(19) United States
(12) Patent Application Publication
(10) Pub. No.: US 2010/0277490 A1
(43) Pub. Date: Nov. 4, 2010

(54) IMAGE DRIVING APPARATUS AND DISPLAY APPARATUS INCLUDING THE SAME

(76) Inventors: Hyoung-Sik Nam, Incheon-si (KR); Byung-Hyuk Shin, Seoul (KR); Jee-Hoon Jeon, Hwaseong-si (KR); Min-kyu Park, Asan-si (KR); Kyung-woo Kim, Cheonan-si (KR)

Correspondence Address: Innovation Counsel LLP, 21771 Stevens Creek Blvd, Ste. 200A, Cupertino, CA, 95014, US

(21) Appl. No.: 12/770,555

(22) Filed: Apr. 29, 2010

(30) Foreign Application Priority Data
Apr. 30, 2009 (KR) 10-2009-0038434

(51) Int. Cl. G09G 5/00

(52) U.S. Cl. 345/581

(57) ABSTRACT

A wireless and multi-channel re-transmitting link is provided between an image displaying part that is housed in a first housing and an image data processing part that is housed in a segregated second housing. The wireless link allows the image displaying part to be more easily moved around and to be made lighter and slimmer in profile because at least some image data processing can be carried out in the second housing and yet cumbersome cables are not needed for linking the pre-processed image data from the second housing to the first housing. In one embodiment, the data bandwidth. that is to he transmitted through the wireless link is first reduced; for example the frame refresh rate of image frames conveyed through each of the wireless channels is made less than the frame refresh rate of the original image signal. In one embodiment, the reduced number of frames per unit time are further frequency wise and temporally wise spaced apart from one another by alternatingly sending them through different wireless channels at different times. Thus if a burst of noise strikes one of the plural re-transmission channels, the likelihood that it will corrupt a frame is reduced.

### CROSS-REFERENCE TO RELATED APPLICATION

This application claims priority to and the benefit of Korean Patent Application No. 10-2009-0038434 filed in the Korean Intellectual Property Office on Apr. 30, 2009, the entire contents of which application are incorporated herein by reference.

### BACKGROUND

(a) Field of Disclosure

The present disclosure of invention generally relates to a driving apparatus for a display apparatus and a display apparatus including the same. The present disclosure relates more specifically to an image display system that displays images whose image data has been transmitted thereto wirelessly.

(b) Description of Related Technology

A typical display apparatus includes an image data processing part which receives an original signal (input image signal) transmitted over a first transmission channel (e.g., channel CH0) from an external graphics sourcing apparatus. The data processing part then responsively generates a first image signal and a first control signal which are next transmitted to an associated image displaying part of the display apparatus. Extraction of the first control signal from the original input image signal may include use of a clock recovery operation to extract one or more clock and synchronization signals that are then included in the first control signal. The latter displaying part receives the first image signal and the first control signal and responsively causes corresponding images to be displayed on a respective display panel. The image displaying part typically includes a timing controller that receives the first image signal and the first control signal, and responsively generates individual column drive signals and row scan signals as well as scan start signals where the latter are then transmitted to the display panel that displays images according to the first imaging signal and first control signal. The display apparatus further typically includes a single power circuit supplying power to both the image data processing part and to the image displaying part. The displaying part may include a liquid crystal display (LCD) apparatus, an organic light emitting diode (OLED) type of display or a different kind of display. When the displaying part is of the LCD apparatus type, the display apparatus further typically includes a backlighting unit that supplies a back light to the LCD panel and an inverter circuit that is powering and controlling operations of the backlighting unit.

The image data processing part (hereafter also “imaging part” for short) and the image displaying part (hereafter also “display part” for short) may be connected to one another through a wired interface. When the imaging part and the displaying part are so connected and integrated into a same display set (e.g., display housing), the size and weight of the display set may be disadvantageously cumbersomely large and heavy. So it has been suggested that it might be desirable to be able to reduce size and weight of the display set by segregating the respective imaging part and the displaying part into separate respective housings (sub-sets) that are individually powered. In one class of embodiments, the imaging part and the displaying part which are respectively disposed in the different housings (sub-sets) interface with each other through a wireless interface. A number of problems are associated with such wireless re-transmission of the processed image signals. First, noise bursts or other causes for data transmission error or failure through the inter-housing wireless interface (e.g., interruption caused by temporary loss of the transmission channel) can significantly degrade the quality of the images displayed by the segregated displaying part. Secondly, re-transmission of the processed image signals may consume additional power that is not otherwise consumed by systems that do not have a wireless re-transmission in the midst of their operations.

The above information disclosed in this Background of Technology section is only for enhancement of understanding of the background of the remainder of the disclosure and therefore it may contain information that does not form part of the prior art that is already known to persons of ordinary skill in the relevant art. It is understood that a driving market force in the displays art is to reduce the costs of displays while at the same time improving the quality of images displayed by them. Such a driving market force may dissuade artisans from pursuing the segregated housings and wireless re-transmission approach disclosed herein.

### SUMMARY

A technical effect and useful result of one or more embodiments in accordance with the present disclosure is to provide a driving apparatus of a light weight and slim profile liquid crystal display (LCD) and a driving method to display images on the LCD while reducing probability of transmission errors or transmission failures for signals that are wirelessly communicated between segregated elements of the display apparatus. Another useful technical effect that may be had from one or more of the disclosed embodiments is that of reduced re-transmission power consumption.

A display apparatus in accordance with the disclosure comprises an image data processing part housed in a first housing and an image displaying part housed in a segregated second housing where an at least partially-wireless communication link is provided between the segregated first and second housings. The first and second housings may be separately powered. The image data processing part receives a first sequence of frame-defining signals having a first frame refresh rate (N) associated with them. The image data processing part distributes the frames of the received first sequence across a plurality of separate re-transmission channels such that the effective frame refresh rate (M) in each of the re-transmission channels will be less than N. In one embodiment, the re-transmitted frames are temporally spaced apart in each of the re-transmission channels so as to lessen the chance that a given frame will be corrupted by a short burst of noise occurring in that re-transmission channel at a given time point. In one embodiment, only every other frame is sent through the plural re-transmission channels so that power consumed by the re-transmission system is reduced. In another embodiment, frames are duplicated in each of the re-transmission channels so that there is greater likelihood that at least one non-corrupted version of a unique frame will get through the channel even if the other copy is corrupted. In yet another embodiment, interpolated frames are inserted between original frames in each of the plural re-transmission channels. As a result, even if a burst of noise or interference strikes one of the re-transmission channels, an acceptable moving or other image can be timely displayed on the display apparatus. At the same time, since thanks to the substantially wireless interconnect between housings; the image displaying part is not tied by bulky or inflexible communication cables to the image processing part. As a result, a lighter in weight and/or slimmer image displaying part can be provided that is easier to move around and/or is easier to place on a crowded or small desk area.

### BRIEF DESCRIPTION OF THE DRAWINGS

The accompanying drawings briefly described below illustrate exemplary embodiments, which together with the detailed description; serve to explain the principles of the present disclosure. In the accompanying drawings:

FIG. 1 is a block diagram of a display apparatus according to an exemplary embodiment where the apparatus receives an original image signal over an image sourcing channel;

FIG. 2 is shows a detailed block diagram of a display apparatus according to an exemplary embodiment where data derived from the original image signal is retransmitted over a substantially wireless link;

FIG. 3 is a more detailed block diagram of one embodiment of FIG. 2 wherein the retransmitted data is first modulated so as to be spread across a plurality of wireless channels before being retransmitted over the wireless link;

FIG. 4 is a multi-channel content versus timing diagram showing how various frame-defining signals may be distributed across a plurality of wireless channels in accordance with one embodiment (power saving embodiment) of the display apparatus of FIG. 3;

FIG. 5 is a block diagram of a display apparatus according to another exemplary embodiment;

FIG. 6 is a multi-channel content versus timing diagram showing various signals which are used in the display apparatus of FIG. 5;

FIG. 7 is a block diagram of a display apparatus according to yet another exemplary embodiment; and

FIG. 8 is a multi-channel content versus timing diagram showing various signals which may be used in the display apparatus of FIG. 7.

### DETAILED DESCRIPTION

The present disclosure will now be described yet more fully hereinafter with reference to the accompanying drawings, in which exemplary embodiments in accordance with the present teachings are shown.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

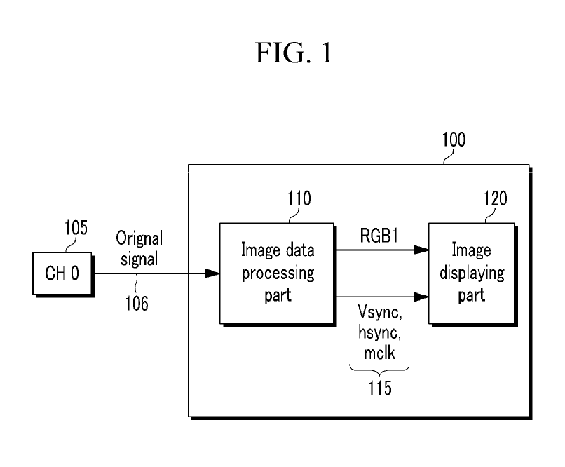

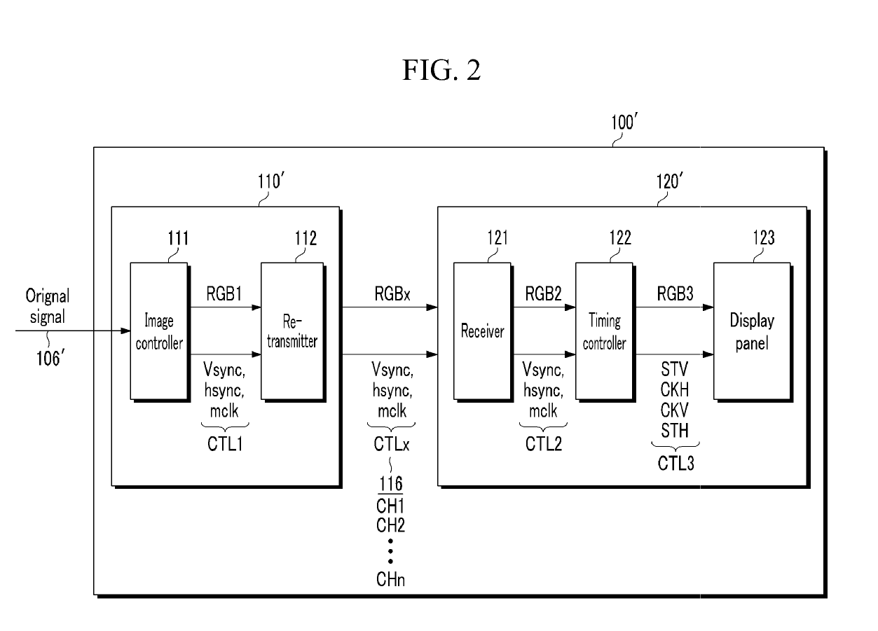

FIG. 1 shows a block diagram of a first display apparatus 100 according to the present disclosure and FIG. 2 shows a more detailed block diagram of one embodiment 100′ of such a display apparatus 100.

Referring FIG. 1, the display apparatus (100) includes an imaging part (image data processing part, 110) and a displaying part (image display part 120) which are understood herein to be housed in spaced apart and separately-powered housings and are understood to be communicating with one another over an inter-housing communications link 115. In one embodiment, the inter-housing communications link 115 is a wireless link such as an RF link or an optical link or a mix of both electromagnetic and optical wireless couplings. In one embodiment, each of the segregated housings is separately powered so that the displaying part (image displaying part 120) may be of a lighter weight and/or of a slimmer profile than would be possible if the circuitry and power supply for the image data processing part 110 were integrally included in the housing of the image displaying part 120.

The imaging part 110 receives an originally sourced signal 106 over a source transmission channel (CH0) from an external source apparatus (e.g., which could be linked to an entertainment transmission network or to a DVD disc player or another such mechanism) and the imaging part 110 generates a correspondingly processed first image signal (e.g., RGB_1) and first control signal (CTL_1). The first control signal may include one or more of a vertical synchronization signal (VSYNC), a horizontal synchronization signal (HSYNC) and a main clock signal (MCLK) that have been extracted from the originally sourced signal 106. Extraction may occur for example by clock recovery techniques. The first image data signal, if encoded as an RGB colors signal, may include a red (R) original data signal, a green (G) original data signal and a blue (B) original data signal which are related to red color pixels, green color pixels and blue color pixels, respectively expected to be on a standard CRT or alike RGB display apparatus within the displaying part 120. (The displaying part 120 may alternatively use a different displaying format such as RGBW, in which case the displaying part 120 may include gamut remapping means (not shown) for mapping to its unique displaying format.) More specifically, the displaying part 120 may receive the first image signal (e.g., RGB_1) and the first control signal (CTL1, e.g., vsysnc, hsync, mclk) and may responsively cause display on an included display apparatus (e.g., RGB or RGBW or other LCD, not shown) of images according to the first image signal RGB1 and the first control signal CTL1. Although not yet shown, it is to be appreciated that the original image data signals are provided from the source channel CH0 at an image refreshing rate of N frames per second (e.g., N=60 frames/sec) and that the image displaying part 120 is expected to be able to refresh its displayed image accordingly. The first control signal CTL1 is provided for supporting the image refreshing rate (N frames/sec) of the original image data signal RGB1.

Referring FIG. 2, in one embodiment, the imaging part 110 may include an image controller (111) and a signals re-transmitter (112). The image controller 111 receives an original signal 106′ originally transmitted from an external source apparatus (not shown) by way of transmission channel CH0 and generates the corresponding first image signal (e.g., RGB1) and first control signal (CTL1). The first control signal may include a vertical synchronization signal (VSYNC), a horizontal synchronization signal (HSYNC) and a main clock signal (MCLK). The first image signal may include a red original image signal R, a green original image signal G and a blue original image signal B which are related to red color, green color and blue color pixels, respectively expected to be present in the image display panel 123 (e.g., CRT or LCD). The re-transmitter 112 receives the first image signal and first control signal from the image controller 111 and responsively outputs retransmitted versions of the first image signal and of the first control signal to the display part 120 over a plurality of signal transmission channels 116 (e.g., CH1, CH2, . . . CHn) which preferably are all wireless signal transmission channels. In one embodiment, each of the signal transmission channels 116 supports an image data refresh rate of N frames per second.

The displaying part 120′ may include a receiver (121), a timing controller (122) and a display panel (123, e.g., an LCD panel). The receiver receives the re-transmitted first image signal and the re-transmitted first control signal from the wireless transmission channels 116 (which are driven by the transmitter 112) and outputs a corresponding second image signal (RGB2) and a second control signal (CTL2) to the timing controller 122. In one alternate embodiment, one or more of the communication channels 116, the re-transmitter 112, and the receiver 121 may utilize a wired interface such as an LVDS (Low Voltage Differential Signaling) interface, a RSDS (Reduced Signal Differential Signaling) interface, a mini-LVDS (mini-Low Voltage Differential Signaling) interface or an AiPi (Advanced Intra Panel Interface). In the more preferred embodiments, however, all of the communication channels 116 between the re-transmitter 112 and the receiver 121 are wireless interface channels (e.g., radio frequency links (RF—including high frequencies) and/or optical links). Since the image displaying part 120′ of the latter, all wireless; embodiment does not need bulky cables connecting it to the image processing part 110′, the displaying part 120′ may be made lighter in weight and/or slimmer in profile and thus easier to move around and use by a user because it is not encumbered by bulky or inflexible connection cables. The display panel 123 may be a liquid crystal display (LCD), organic light emitting diode display (OLED) or a different type of display that produces optical images in response to a third image signal (RGB3) and third control signal (CTL3) received from the timing controller 122. Although not shown, the display panel 123 of the wirelessly coupled image displaying part 120′ may include integrally provided touch sensing means and/or image scanning means.

The timing controller 122 may convert the second image signal and second control signal to a third image signal (RGB3) and third control signal CTL3, respectively. The third control signal CTL3 may include a horizontal scan starting signal (STH), a vertical scanning starting signal (STV), a vertical clock signal (CKV) and a horizontal clock signal (CKH). The third image signal (RGB3) may include a red image signal R′, a green image signal G′ and a blue image signal B′ which are related to red color, green color and blue color, respectively. The timing controller 122 may compensate the colors and/or gammas of the second image signal (RGB2) so as to generate a gamma corrected and/or color corrected third image signal (RGB3) for driving the display panel 123 according to specific characteristics of that display panel 123. The timing controller may include means for over-driving one or more portions of the second image signal to thereby generate an over-driven third image signal having enhanced contrast features. Such over-driving may be applied for example, for compensating for slow movement of liquid crystal molecules in an LCD panel if panel 123 uses liquid crystal molecules. The sequence of operations for performing gamma correction, color correction, over-drive correction and/or other compensations may be carried out in the here recited order or in another order.

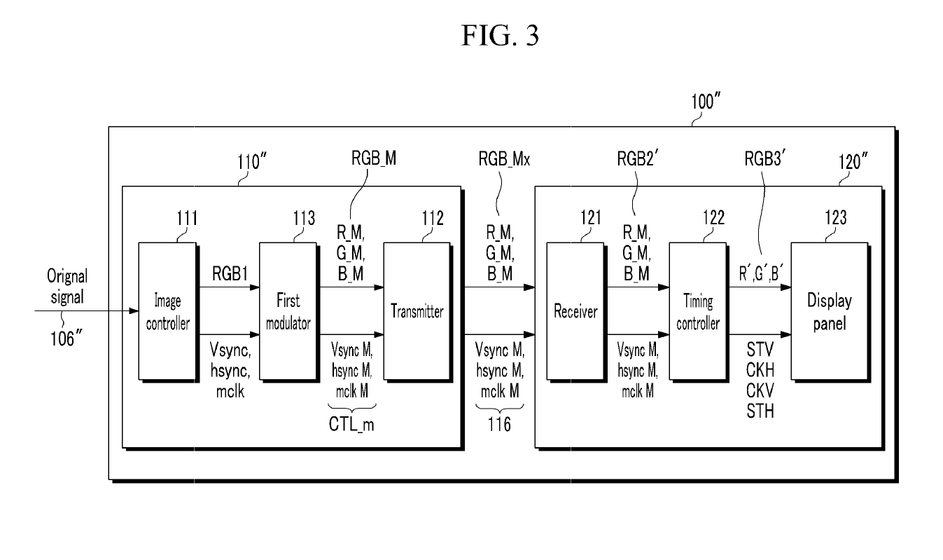

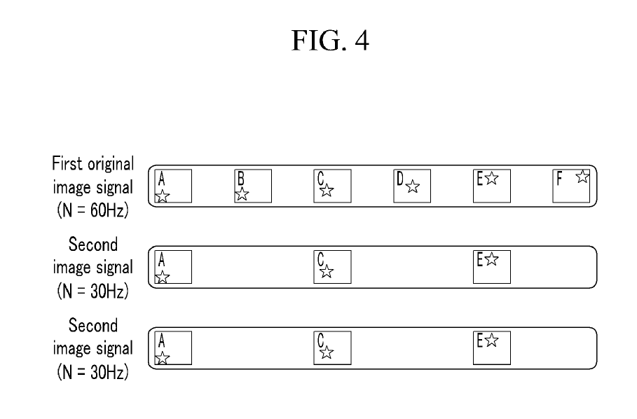

FIG. 3 shows a block diagram of a display apparatus according to another exemplary embodiment and FIG. 4 shows frequency bands and frame rates and contents of various signals which are used in one power-saving version of the embodiment of FIG. 3.

Referring FIG. 3, the illustrated embodiment of the display apparatus (100″) includes an imaging part (110″) and a displaying part (120″) housed in respectively segregated housings and interconnected by a wireless link 116″. The imaging part may include an image controller (111″), a re-transmitter (112″) and a first modulator (113″) interposed between the image controller and the re-transmitter. Once again, the image controller 111″ of FIG. 3 may receive an original signal 106″ transmitted from an external source apparatus over a source channel (CH0) where the original signal 106″ has an image refresh rate of N frames per second. The image controller 111 may generate a corresponding first image signal (RGB1_N) and a corresponding first control signal (CTL1_N) extracted from the original signal 106″, where here, N may refer both to a number of information components included in the signals produced by the image controller 111 and a corresponding transmission rate or bandwidth needed to transmit the N informational components without substantial loss of informational content. More specifically, in one embodiment, the first image signal and the first control signal may he structured to support a first frame refresh rate of N Hz (where Hz may denote here a number of frames per second and where N is a natural number and thus for example, 60 Hz represents 60 frames per second.)

The first control signal may include a first vertical synchronous signal (VSYNC_N), a first horizontal synchronous signal (HSYNC_N) and a first main clock signal (MCLK_N), where the underscore plus letter “N” suffix represents the intended frame refresh rate (e.g., 60 frames per second). The first image signal RGB1_N may include a first red image signal R1_N, a first green image signal G1_N and a first blue image signal B1_N which are related to red color, green color and blue color, whose informations are respectively provided in accordance with the N frames/second frame refresh rate.

The first modulator 113″ of FIG. 3 receives the first control signal (CTL_N) and the first image signal (RGB1_N) from the image controller and generates a plurality of re-modulated second image signals (RGB2_M)' and corresponding second control signals (CTL2_M) for transmission over multi-channel wireless link 116. (In an alternate embodiment, one or more of the channels in link 116 may be a wired channel.)

The second image signals (RGB2_M) and the second control signals (CTL2_M) may be signals each related to a second frame refresh rate of M Hz (where M is a natural number less than N, e.g., 30<60). However, since there are plural such lower rate channels (e.g., three separate color channels instead of one RGB channel for all colors) the overall information transmission bandwidth provided by the output of the first modulator 113 equals or exceeds the bandwidth of the output of the image controller 111 of FIG. 3 (e.g., 3 times 30 Hz=90 Hz which is greater than 60 Hz). Transmitting the color planes each in its own wireless channel and at a slower rate inside each channel is one possibility. Another way that the data can he subdivided is by wirelessly transmitting different frames of data in different wireless channels. Another way that the data can be subdivided is by wirelessly transmitting different frames of data firstly in one wireless channel while the second is off and then in the second wireless channel while the first is off so as to thereby reduce the amount of power consumed by the wireless re-transmission portion of the system as will be seen in the case of FIG. 4.

Each of the second control signals (CTL2_M) may include a respective second vertical synchronous signal (VSYNC_M), a second horizontal synchronous signal (HSYNC_M) and a second main clock signal (MCLK_M). The second image signal (RGB2_M) may include for each re-transmission channel, a second red original image signal R_M, a second green original image signal G_M and a second blue original image signal B_M which are related to red color, green color and blue color, respectively.

The inter-housing transmitter 112″ may receive the second original image signals and second original control signals from the first modulator 113 and may output re-transmitted versions, for example, R_Mx, G_Mx, B_Mx and CTL_Mx of these to the display part by way of the multi-channel wireless link 116. The transmitted signals, R_Mx, G_Mx, B_Mx and CTL_Mx may be RF signals and/or optical signals.

The image displaying part 120″ of FIG. 3 may include a receiver (121″), a timing controller (122″) and a display panel (123″). The receiver 121″ receives the re-transmitted versions RGB_Mx, CTL_Mx of the modulated signals and responsively outputs the second image signals RGB2′_M and second control signals CTL2′_M from the link channels 116 to the timing controller 122″. As mentioned, the interface 116″ between the transmitter and the receiver may alternatively include one or more wired interfaces such as an LVDS (Low Voltage Differential Signaling) interface, a RSDS (Reduced Signal Differential Signaling) interface, a mini-LVDS (mini-Low Voltage Differential Signaling) interface or an AiPi (Advanced Intra Panel Interface). The interface 116 between the transmitter and the receiver is more preferably an all wireless interface. The display panel may be a liquid crystal display (LCD), organic light emitting diode display (OLEDD) or a different type of display.

The timing controller 122″ may convert the second image signals and second control signals to a nominally N frames per second, third image signal RGB3_N and its corresponding control signals, CTL3_N respectively. While the third control signal, CTL3_N is nominally set for N frames per second, under certain circumstances (to be described below) it may be temporarily reduced to correspond to a lower frames refresh rate of M Hz. The control signal may include a horizontal starting signal (STH), a vertical starting signal (STV), a vertical clock (CKV) and a horizontal clock (CKH). The third image signal RGB3′ may include a red image signal R′, a green image signal G′ and a blue image signal B′ which are related to red color, green color and blue color, respectively. The timing controller may compensate the color or gamma of the second original image signal to generate the image signal. The timing controller may over-drive the second original image signal to generate the image signal, over-driving is applied for compensating for slow movement of the liquid crystals. The compensation of the color or gamma of the second original image signal and over-driving of the second original image signal may be followed by one another.

The display panel 123″ of FIG. 3 may receive the image signal and the control signal from the timing controller and display corresponding images. The refresh rate of the images may be either N Hz or M Hz depending on circumstances as shall now be described with reference to the embodiment of FIG. 4.

The first modulator 113″ may include a memory apparatus (not shown) that temporarily stores sequential frames A, B, C, D, E, F, etc. of the original image signal (CH0) in the received order (where each of respective frames A, B, C, D, E, F, . . . etc. can contain its own unique informational content). The memory apparatus (not shown) allows for time multiplexed re-transmission of the frames as chronologically spaced apart non-sequential frames, (e.g., A, C, E and B, D, F) over the plural re-transmission channels (e.g., CH1, CH2).

In one embodiment, rather than wirelessly re-transmitting all of frames A, B, C, D, E, F, . . . etc., only one out of every J frames is wirelessly re-transmitted over a plurality of wireless transmission channels. More specifically, for the embodiment of FIG. 4, the first modulator converts the first control signal and the first image signal (RGB1_N) to the second image signals (RGB2_M) and second control signals (CTL2_M) whose informational content is distributed over the plural re-transmission channels (e.g., CH1, CH2). In one embodiment (not shown) chronologically spaced apart non-sequential frames, (e.g., A, C, E and B, D, F) are transmitted over the separate plural re-transmission channels (e.g., CH1, CH2) each at a slower refresh rate of M frames per second. As a result, occurrence of a noise burst in one of the channels (e.g., in CH2) or a temporary loss of operability of the one of the re-transmission channels (e.g., CH1, CH2) will not fatally affect the ability of the display panel 123 to continue to display image frames since the display panel 123 and its timing controller 122 can be automatically switched, as mentioned above, from the N frames/second rate (e.g., 60 Hz) to the M frames/second rate (e.g., 30 Hz) in automatic response to detection of a problem in one of the plural re-transmission channels (e.g., CH1, CH2). In one embodiment, each of the plural re-transmission channels (e.g., CH1, CH2) has a bandwidth less than the bandwidth of the original source channel (CH0) but sufficient bandwidth to carry the slower rate frames, (e.g., A, C, E or B, D, F) transmitted over that channel. In one embodiment, a sufficient number of slower-rate wireless channels, CH1, CH2, . . . CHk are provided so that the total bandwidth of the plural wireless channels, CH1, CH2, . . . CHk equals or exceeds the total information-conveying bandwidth of the original channel CH0. Thus, in the case where there is a momentary or longer failure of one of these wireless channels (e.g., CH1, CH2, . . . CHk, where k is a natural number) due to interference noise or due to other problems, the image displaying part 120″ nonetheless receives some corruption-free frames, albeit at the slower rate, over the not degraded other channel(s) and thus the user is able to continue to usefully use the wirelessly-linked display part 120″ in a somewhat degraded but still useful mode.

In another embodiment, at least one of the plural re-transmission channels (e.g., CH1, CH2) has a bandwidth at least equal to the bandwidth of the original source channel (CH0) and thus, in the case of failure of a sister re-transmission channel, the redundant and full bandwidth re-transmission channel which is not undergoing failure (e.g., CH1) is automatically selected and used to transmit the frames at the full N frames per second rate.

FIG. 4 shows the case where each of the wireless channels CH1 and CH2 has half the bandwidth as source channel CH0 (where CH0 has an ability to transmit 60 frames per second while CH1 and CH2 each can only transmit at 30 frames/sec). Moreover, only every other frame (e.g., A, C, E, etc.) is transmitted first over CH1 and then over CH2 so as to reduce power consumption by the wireless re-transmission system. During normal usage mode, if each of the wireless channels CH1 and CH2 is operational to transmit 30 frames per second; one channel is turned off while the other is turned on (powered on) and then vise versa so as to thereby distributed or spread the re-transmissions over plural wireless channels. For example, channel CH1 transmits the frames, A, C, E at a rate of only 30 frames per second while channel CH2 is turned off and then CH2 transmits the next set of odd numbered frames, G, I, K (not shown) while channel CH1 is turned off. The even numbered alternate frames, B, D, F, etc. are deleted in this particular embodiment. If there is a temporary noise burst in the second wireless channel CH2 for example, there is a high likelihood (50%) that the burst will not overlap with a frames transmission period that uses channel CH2. On the other hand, if the second wireless channel CH2 becomes interrupted for a longer period of time, system my switch over to continuously using only the first channel CH1 at the rate of 30 frames per second. The displaying part 120″ automatically detects that the second wireless channel CH2 is not working and in response, the displaying part 120″ automatically commands the transmitter 112″ in the imaging part 110″ to persistently transmit all of the odd-numbered frames at 30 frames per second. Accordingly, the uninterrupted frames of the first wireless channel CH1 get through and are usefully utilized.

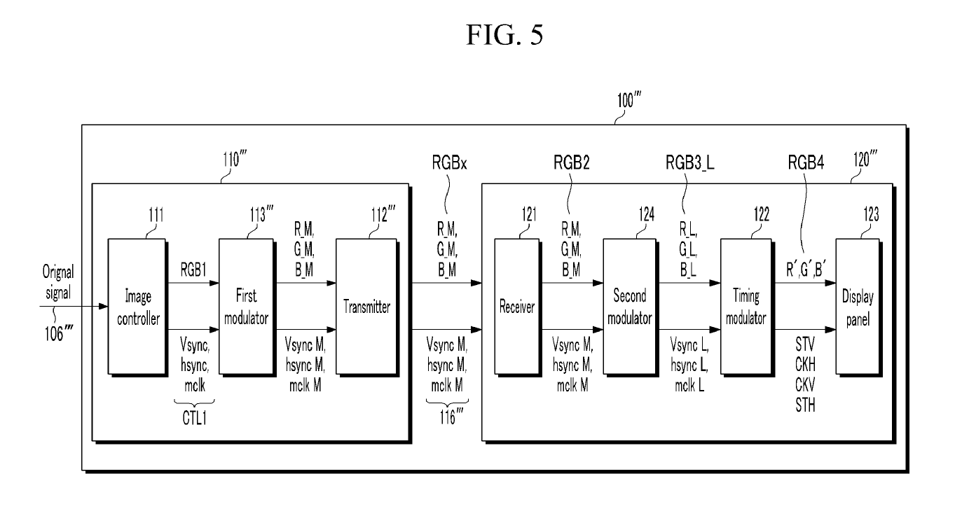

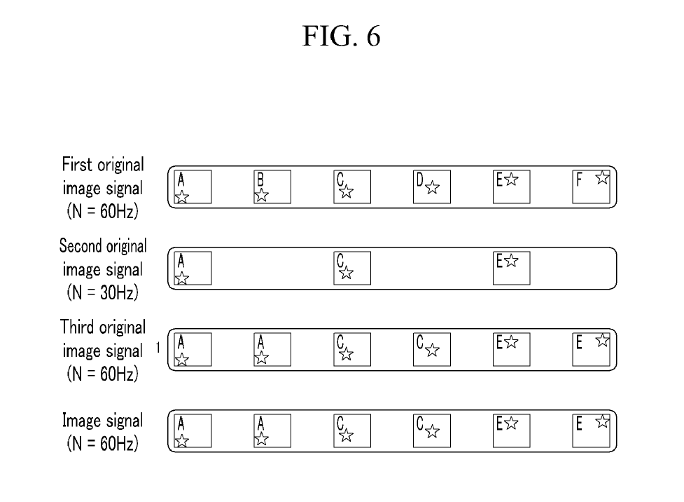

FIG. 5 shows a block diagram of a display apparatus according to another exemplary embodiment 100′″ wherein the displaying part 120′″ includes a second modulator 124. FIG. 6 is a multi-channel content versus timing diagram showing various signals which are used in the display apparatus of FIG. 5.

Referring to FIG. 5, the display apparatus (this time denoted as 100′″) includes a corresponding imaging part (110′″) and a displaying part (120′″). The imaging part may include an image controller (111′″), a transmitter (112′″) and a first modulator (113′″). The image controller may receive an original signal 106′″ from an external apparatus over a source channel (CH0) and may generate a corresponding first image signal RGB1 and a first control signal CTL1. The first image signal and the first original control signal may be signals that represent sequential frames (e.g., A, B, C, D, etc.) of synchronized image data conveyed at a respective first frames refresh rate of N frames/second (where N is a natural number such as 30, 60 or 120).

The first control signal may include a first vertical synchronization signal (VSYNC_N), a first horizontal synchronization signal (HSYNC_N) and a first main clock signal (MCLK_N) each corresponding to the N Hz refresh rate. The first image signal (RGB1_N) may include a first red original image signal R_N, a first green original image signal G_N and a first blue original image signal B_N which are related to red color, green color and blue color, respectively.

The first modulator 113′″ may receive the first control signal and the first image signal from the image controller and may responsively generate a second image signal RGB2_M and a second control signal CTL2_M. The second image signal and the second control signal may be signals related to a second image refresh rate of M Hz (where M is a natural number less than N). As was the case in the embodiment of FIG. 3, although the per wireless channel image-refresh-rate of M frames per second is less than the image-refresh-rate of the source channel CH0 (N frames per second), because there are a sufficient plural number of wireless channels, the full informational content of the source channel CH0 can be transmitted over the wireless channels 116′″ without loss of information in the case where all the wireless channels are operational and uninterrupted. On the other hand, if power reduction is desired, the wireless re-transmission means may transmit only a subset of the original number of frames (e.g., only the odd numbered ones).

Still referring to first modulator 113′″, the second control signal output therefrom may include a second vertical synchronous signal (VSYNC_M), a second horizontal synchronous signal (HSYNC_M) and a second main clock (MCLK_M). The second image signal output therefrom may include a second red original image signal R_M, a second green original image signal G_M and a second blue original image signal B_M which are related to red color, green color and blue color, respectively. Again, as in the case of FIG. 3, splitting up the data into separately colored frames (e.g., three separate color channels instead of one RGB channel for all colors) is one way to maintain the overall information transmission bandwidth because the output bandwidth of the first modulator 113′″ equals or exceeds the bandwidth of the output of the image controller 111′″ of FIG. 5 (e.g., 3 times 30 Hz=90 Hz which is greater than 60 Hz). Transmitting the color planes each in its own wireless channel and at a slower rate inside each channel is one possibility. Another way that the data can be subdivided is by wirelessly transmitting different frames of data in different wireless channels. For purpose of power saving, some of the original frame content may be omitted as will be seen in FIG. 6.

The re-transmitter 112′″ of FIG. 5 may receive the second image signal and second control signal from the first modulator and correspondingly output the second transmitted image signal RGBx and second transmitted control signal CTL2x to the display part.

The displaying part 120′″ may include a corresponding receiver (121), a timing controller (122), a display panel (123) and a second modulator (124) connection-wise interposed between the receiver and the timing controller as shown in FIG. 5.

The receiver receives the second transmitted image signal RGB2 and second transmitted control signal CTL2x from the multi-channel wireless link 116′″. The receiver responsively outputs the corresponding image signals and control signals to the second modulator 124. As mentioned above, the interface 116′″ between the transmitter and the receiver may include a wired interface channel such as an LVDS (Low Voltage Differential Signaling) interface, a RSDS (Reduced Signal Differential Signaling) interface, a mini-LVDS (mini-Low Voltage Differential Signaling) interface or an AiPi (Advanced Intra Panel Interface). The interface between the transmitter and the receiver may more preferably be an all wireless interface. The display panel may be a liquid crystal display, organic light emitting diode display or a different type of display.

The second modulator 124 may receive the image and control signals each still having a respective frame rate of M frames/second from the receiver and the second modulator 124 may then mix them and remodulate them to produce a sequence of usable frames appearing at an intermediate rate of L frames/second (where L is a natural number such that N≧L>M).

The remodulated third control signal CTL3_L may include a third vertical synchronous signal (VSYNC_L), a third horizontal synchronous signal (HSYNC_L) and a third main clock signal (MCLK_L). The remodulated third image signal RGB3_L may include a third red original image signal R_L, a third green original image signal G_L and a third blue original image signal B_L which are related to red color, green color and blue color, respectively.

The timing controller may convert the third image signal and third original control signal to a fourth image signal RGB4 and a fourth control signal CTL4, respectively. The fourth image signal and the fourth control signal may be signals related to the fourth image refresh rate of L frames per second. L may he automatically changed in response to automatically detected and changeable circumstances (e.g., how many of the plural wireless channels CH1, CH2, . . . CHk are operational at the moment). The fourth control signal may include a horizontal starting signal (STH), a vertical starting signal (STV), a vertical clock (CKV) and a horizontal clock (CKH). The image signal may include a red image signal R′, a green image signal G′ and a blue image signal B′ which are related to red color, green color and blue color, respectively. The timing controller may compensate the color or gamma of the third original image signal to generate the image signal. The timing controller may over-drive the third original image signal to generate the image signal, over-driving is applied for the fast movement of the liquid crystals. The compensation of the color or gamma of the third original image signal and over-driving of the third original image signal may be followed by another.

The display panel may receive the image signal and the control signal from the timing controller and display images. The refresh rate of the images may be L Hz and the timing controller 122′″ may be configured to operate with a changeable value for L.

Each of the first modulator and the second modulator may include a respective memory apparatus (not shown) for temporarily storing the received frame sequences at a first rate and outputting a subset or superset of the received frame sequences at a second rate. Referring FIG. 6, in one embodiment, the first modulator converts the first control signal and the first image signal to the second image signal and second control signal. The original refresh rate N Hz of the first image signal is larger than the possible refresh rate for unique frames of M Hz of the re-transmitted data in each re-transmission channel. The effective frequency of the unique signals transmitted through each of the interface channels between the transmitter and the receiver is thus reduced. So, transmission errors between the imaging part and the display part can be reduced, even when the first original control signal and the first original image signal is transmitted through the unstable interfaces. In FIG. 6, channel CH1_M carries repetitions of each of the A, C and E frames. On the other hand, in one embodiment (not shown), channel CH2_M may carry repetitions of each of the B, D and F frames. Thus the refresh rate of unique data in each of the CH1 and CH2 channels is M≦N. In the illustrated embodiment, each of channels CH1_M and CH2_M carries repetitions of only the odd numbered frames (e.g., A, C, E) white the even numbered ones are not wirelessly transmitted. CH1_M is active at one time period while CH2_M is turned off and then vise versa. If short noise bursts occur in either or both of the re-transmission channels CH1_N and CH2_N so as to obliterate one of the redundantly carried frames of image data, the noise infected channel may still be able to deliver a noise free version of that frame thanks to the redundancy of image data carried by that re-transmission channel. In one embodiment, error detecting techniques such as CRC are used on each frame to determine whether that frame's worth of data has been corrupted by noise. If yes, an alternate not-infected copy of the same frame is automatically used.

The second modulator converts the second control signal and the second image signal RGB2 to the third image signal RGB3_L and third control signal CTL3_L. The refresh rate L Hz of the third image is larger than the effective refresh rate M Hz of each of the re-transmission channels. Thus, the frequency of unique signals output by the second modulator is increased. So, the timing controller and the display panel can display an image of enhanced quality. The crosstalk and flicker of the image displayed on the display panel is also reduced.

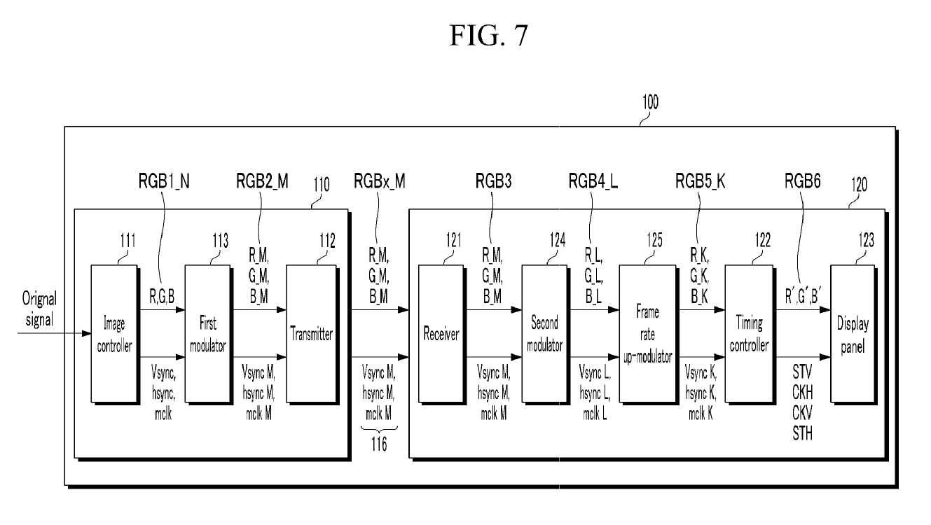

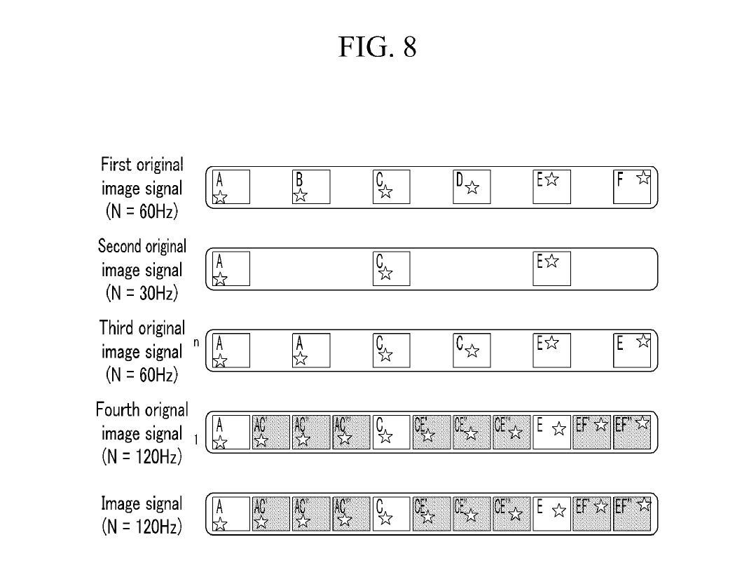

FIG. 7 shows a block diagram of a display apparatus according to another exemplary embodiment 100″″ and FIG. 8 shows in terms of channel frequencies the various signals which can be wirelessly transmitted for purpose of reducing power consumption by the re-transmission portion while still providing adequate data for use in the display apparatus. Referring FIG. 7, the display apparatus (100″″) includes an imaging part (110″″) and a display part (120″″). The imaging part may include an image controller (111″″), a transmitter (112″″) and a first modulator (113″″). The image controller (111″″) may receive an original signal from an external apparatus and generate a first processed image signal RGB1_N and a first processed control signal CTL1_N. The first processed image signal RGB1_N and the first processed control signal CTL1_N may be signals derived from and related to a first image, the refresh rate of the first image is N Hz. (N is a number expressing a number of frames of image data to be provided per second or alternatively in another per unit time basis.)

The first processed control signal CTL1_N may include a first vertical synchronous signal (VSYNC_N), a first horizontal synchronous signal (HSYNC_N) and a first main clock (MCLK_N). The first image signal RGB1_N may include a first red original image signal R_N, a first green original image signal G_N and a first blue original image signal B_N which are related to red color, green color and blue color, respectively.

The first modulator 113″″ may receive the first processed control signal CTL1_N and the first processed image signal RGB1_N from the image controller 111″″ and generate a second processed image signal RGB2_M and a corresponding second processed control signal CTL2_M each of respective unique, frames per unit time refresh rate M<N. The reduced refresh rate (M) may be realized in one embodiment simply by periodically deleting some of the original frames (for example by omitting frames B, D, F, etc. as shown in FIG. 8). However, other methods of data compression may be alternatively or additionally used so that the amount of unique (non-redundant) data being transmitted wirelessly across wireless link 116″″ is reduced relative to the original source data received by image controller 111″″.

The second control signal may include a second vertical synchronous signal (VSYNC_M), a second horizontal synchronous signal (HSYNC_M) and a second main clock (MCLK_M). The second original image signal may include a second red original image signal R_M, a second green original image signal G_M and a second blue original image signal B_M which are related to red color, green color and blue color, respectively.

The transmitter may receive the second image signals and second control signals from the first modulator 113″″ and may output re-transmitted versions of these over respective ones of plural re-transmission channels 116″″ (e.g., wireless channels) for receipt by the display part.

The display part may include a corresponding receiver (121″″), a timing controller (122″″), a display panel (123″″), a second modulator (124″″) and a frame rate controller (125″″).

The receiver receives the re-transmitted versions RGBx_M over the plural re-transmission channels 116″″ and outputs the third image signals RGB3_M and third control signals CTL3_M for receipt and storage within the second modulator 124″″. As mentioned, the interface 116″″ between the transmitter and the receiver may include a wired interface such as an LVDS (Low Voltage Differential Signaling) interface, a RSDS (Reduced Signal Differential Signaling) interface, a mini-LVDS (mini-Low Voltage Differential Signaling) interface or an AiPi (Advanced Intra Panel Interface). The interface between the transmitter and the receiver may be an all wireless interface. The display panel may be a liquid crystal display, organic light emitting diode display or a different type of display.

The second modulator 124″″ may receive the third control signal and the third image signal from the receiver and generate a fourth image signal RGB4_L and a corresponding fourth control signal CTL4_L. The fourth image signal and the fourth control signal may be signals related to and derived from the third image signals RGB3_M and third control signals CTL3_M except that the re-modulated fourth image signal. RGB4_L and fourth control signal CTL4_L are provided according to an intermediate refresh rate of L Hz (where L is a number expressed in terms of frames per second or in terms of other refreshing/updating data provided per unit time where, when consistent units of measure are used, N≧L>M).

The fourth control signal may include a corresponding fourth vertical synchronous signal (VSYNC_L), a fourth horizontal synchronous signal (HSYNC_L) and a fourth main clock signal (MCLK_L). The fourth image signal RGB4_L may include a corresponding fourth red original image signal R_L, a fourth green original image signal G_L and a fourth blue original image signal B_L which are related to red color, green color and blue color, respectively.

The frame rate controller 125″″ may receive the fourth control signal and the fourth image signal RGB4_L from the second modulator and generate a fifth image signal RGB5_K and a corresponding fifth control signal. The fifth image signal and the fifth control signal may be signals related to a forth image refresh rate of K Hz (where K is a number and K>N, for example 120>60). Referring FIG. 8, the frame rate controller may generate interpolated, filler image frames (e.g., AC and CE) by interpolating the data of two or more temporally adjacent frames to thus create filler frames that may be interposed sequentially between spaced apart and transmitted ones of the original frames (e.g., between frames A and C of channel CH1′_M) of the fourth images RGB4_L so as to thus approximately recreate the omitted original frames (e.g., B, D, E). The several frames of interpolated image data that are inserted between two frames of the fourth images RGB4_L may be calculated based on an assumed linear progression or morphing over time as between the two original frames. By using such interpolation, the frame rate controller can increase the effective frame rate of the fourth image signal RGB4_L from L Hz to the K Hz rate of the fifth image signal RGB5_K.

The timing controller 122″″ may convert the fifth image signal and fifth control signal to a sixth image signal RGB6 and a corresponding control signal CTL6, respectively. The sixth image signal and the sixth control signal may be signals related to the fifth image refresh rate of K Hz. The control signal may include a horizontal starting signal (STH), a vertical starting signal (STV), a vertical clock (CKV) and a horizontal clock (CKH). The image signal may include a red image signal R′, a green image signal G′ and a blue image signal B′ which are related to red color, green color and blue color, respectively. The timing controller may compensate the color or gamma of the fourth original image signal to generate the image signal. The timing controller may over-drive the fourth original image signal to generate the image signal, over-driving is applied for the fast movement of the liquid crystals. The compensation of the color or gamma of the fourth original image signal and over-driving of the fourth original image signal may be followed by another.

The display panel may receive the sixth image signal RGB6 and the corresponding control signal CTL6 from the timing controller and display images. The refresh rate of the images may be K Hz or less depending on integrity of signals transmitted over the re-transmission link 116″″.

The first modulator and the second modulator may each comprise a memory apparatus, respectively. Referring to FIG. 7, the first modulator 113″″ converts the first control signal and the first image signal RGB1_N to the corresponding two or more second image signals RGB2_M and second control signals CTL2_M where M≦N. The refresh rate N Hz of the first image signal is typically larger than the refresh rate M Hz of the second image signal RGB2_M. The bandwidth of each of the re-transmitted signals that are transmitted through respective channels of the interface between the image part 110″″ and the displaying part 120″″ is thus reduced and thus less susceptible to broadband bursts of interfering noise. So, transmission errors between the imaging part and the display part can be reduced, even though the full information of the first control signal and of the first image signal RGB1_N are transmitted through the potentially unstable and generally wireless interfaces 116″″.

The second modulator 124″″ converts the third control signal and the third image signal RGB3_M to the corresponding fourth image signal RGB4_L and its respective fourth control signal CTL4_L. The refresh rate L Hz of the fourth image is larger than the refresh rate M Hz of the third image signal RGB3_M. The effective bandwidth of the signals output from the second modulator 124″″ is thus increased after having passed as reduced bandwidth signals through the generally wireless interfaces 116″″.

The frame rate controller converts the fourth control signal and the fourth image signal to the fifth image signal RGB5_K and corresponding fifth control signal CTL5. The refresh rate K Hz of the fifth image is larger than the refresh rate N Hz of the first image signal. The bandwidth of the signals output from the frame rate controller 125″″ is thus increased. So, with the aid of interpolation between frames, the timing controller and the display panel can display an image of enhanced quality even though signals of reduced bandwidth were transmitted through the generally wireless interfaces 116″″. The crosstalk and flicker of the image displayed on the display panel can also be reduced even though the signals are re-transmitted through a wireless link 116″″.

While the present teachings has been described in connection with what is presently considered to be practical exemplary embodiments, it is to be understood that the teachings are not limited to the disclosed embodiments, but, on the contrary, are intended to cover various modifications and equivalent arrangements included within the spirit and scope of the present disclosure.

Accordingly, in the driving apparatus of the display apparatus and the driving method thereof according to an exemplary embodiment of the present display, the display apparatus can display enhanced images and transmission errors of signals between internal elements of the display apparatus can be reduced.

What is claimed is:

1. A display apparatus comprising:
(a) an image signal processing part structured to receive an original image signal from a signal source where the received original image signal has associated with it, a first frames refresh rate (N frames per unit time), the image signal processing part being further structured to derive from the original image signal, plurality of re-transmittable image signals each having a second frames refresh rate (M frames per unit time) that is different from the first frames refresh rate (N); and
(b) an image displaying part structured to receive the plural re-transmittable image signals and to use them for displaying images corresponding to the received original image signal.

2. The display apparatus of claim 1, wherein the image signal processing part comprises an image controller coupled to receive the original image signal and structured to derive therefrom a first image signal (RGB1_N) and a corresponding set of one or more first control signals where the first image signal and the corresponding first control signals have the first frames refresh rate (N) associated with them.

3. The display apparatus of claim 2, wherein the first original signal comprises a first original image signal and a first original control signal formatted to correspond to the first frames refresh rate (N).

4. The display apparatus of claim 2, wherein the imaging part further comprises a first modulator structured to convert the first original signal to one or more second signals each having a respective data refresh rate which is less than that defined by said first frames refresh rate (N).

5. The display apparatus of claim 4, wherein the imaging part further comprises a transmitter structured to wirelessly transmit data representing the one or more second signals to the image displaying part.

6. The display apparatus of claim 1, wherein the second signal comprises a second image data signal and a second control signal.

7. The display apparatus of claim 5, wherein the displaying part comprises a receiver structured to receive the wirelessly transmitted signals from the transmitter.

8. The display apparatus of claim 7, wherein the image displaying part further comprises:
a timing controller structured to receive image data and control signals from the receiver and to generate display compatible image data and control signals therefrom; and
a display panel for which the timing controller generates the display compatible image data and control signals, the display panel being structured to display images according to the image and control signals generated by the timing controller, wherein the refresh rate of the images displayed by display panel can be selectively switched between the first refresh rate (N) and the second refresh rate (M).

9. The display apparatus of claim 8, the second refresh rate is lower than the first refresh rate.

10. The display apparatus of claim 7, the displaying part further comprises a second modulator structured to convert the one or more second signals to corresponding third signals that represent image and control data provided at a third refresh rate (L).

11. The display apparatus of claim 10, wherein the displaying part further comprises:
a timing controller receiving the third signals from the second modulator and generating display panel compatible image data and control signals; and
a display panel structured to interface with the timing controller and to display images according to the display panel compatible image data and control signals, wherein the refresh rate of the images displayed by display panel can be selectively switched to be one of the second (M) and third (L) refresh rates.

12. The display apparatus of claim 11, wherein the second refresh rate (M) is lower than the third refresh rate (L) and the third refresh rate third is same or lower than the first refresh rate (N).

13. The display apparatus of claim 10, the display part further comprising a frame rate controller structured to interpolate the third signals and generate therefrom fourth image signals, wherein the fourth image signals have a corresponding fourth refresh rate (K).

14. The display apparatus of claim 13, the display part further comprising:
a timing controller structured to receive the fourth image signal from the frame rate controller and to generate panel compatible image data and control signals; and
a display panel structured to interface with the timing controller and to display images according to the panel compatible image data and control signals generated by the timing controller, wherein the display panel can operate at the fourth refresh rate.

15. The display apparatus of claim 14, wherein the second refresh rate (M) is lower than the third refresh rate (L), the third refresh rate third is same or lower than the first refresh rate (N), and the fourth refresh rate (K) is higher than first refresh rate.

16. The display apparatus of claim 15, wherein the fourth signal comprises a fourth image data signal and a fourth control signal.

17. The display apparatus of claim 1, wherein the imaging part and the displaying part are interfacing to each other through at least one of a wireless radio interface and a wireless optical interface.

18. The display apparatus of claim 8, wherein the transmitter and the receiver are interfacing to each other through at least one of a wireless radio interface and a wireless optical interface.

19. The display apparatus of claim 11, wherein the transmitter and the receiver are interfacing to each other through at least one of a wireless radio interface and a wireless optical interface.

20. The display apparatus of claim 14, wherein the transmitter and the receiver are interfacing to each other at least one of a wireless radio interface and a wireless optical interface.
